(19) United States
(12) Patent Application Publication
(10) Pub. No.: US 2004/0080687 A1
(43) Pub. Date: Apr. 29, 2004

(54) Dual-display liquid crystal display

(75) Inventor: Li-Sen Chuang, Penghu (TW)

Correspondence Address: Quintero Law Office, 3rd Floor, 1617 Broadway, Santa Monica, CA, 90404, US

(73) Assignee: Toppoly Optoelectronics Corp.

(21) Appl. No.: 10/610,066

(22) Filed: Jun. 30, 2003

(30) Foreign Application Priority Data
Oct. 25, 2002 (TW) 91125225

(51) Int. Cl. G02F 1/1335

(52) U.S. Cl. 349/113

(57) ABSTRACT

A dual-display liquid crystal display structure having first and second display regions. A first substrate and a second substrate opposite the first substrate are provided. A reflective electrode pattern and a transparent electrode pattern are formed on the first substrate, wherein the reflective electrode pattern is located in the first display region and the transparent electrode pattern is located in the second display region. A filter is formed on an interior side of the second substrate. A common electrode is formed on the filter. A liquid crystal layer is disposed between the first substrate and the second substrate. A reflector is disposed on a side of the second substrate in the second display region.

### BACKGROUND OF THE INVENTION

1. Field of the Invention

The present invention relates to a liquid crystal display (LCD) structure, and more particularly, to a dual-display LCD structure for displaying data on front and rear surfaces thereof.

2. Description of the Related Art

The display characteristics of high definition, multicolor displays, include low power consumption, lower voltage requirements and light weight make liquid crystal displays (LCDs) a leading display device technology. LCDs, for example, have been used for several years as displays in, personal digital assistants (PDAs), portable computers, mobile phones, and the like.

Recently, a folding type mobile phone, taking advantage of the advances in fabrication techniques and the desire to display data on front and rear surfaces of the folding portion (or upper housing) thereof, has been developed. A conventional folding type mobile phone utilizes two individual LCDs whose rear surfaces are in contact with each other to achieve a dual-display.

However, since the conventional display device uses two individual displays, two sets of electrical equipment for driving the LCDs are required. Accordingly, the display device increases in size and weight and the fabrication cost also increases.

### SUMMARY OF THE INVENTION

The object of the present invention is to provide a dual-display LCD structure for displaying data on front and rear surfaces thereof.

Another object of the present invention is to provide a dual-display LCD structure with a single liquid crystal layer.

Yet another object of the present invention is to provide a dual-display LCD structure having transmissive and reflective modes.

In order to achieve these objects, the present invention provides a dual-display LCD structure having first and second display regions. A first substrate and a second substrate opposite the first substrate are provided. A reflective electrode pattern and a transparent electrode pattern are formed on the first substrate, wherein the reflective electrode pattern is located in the first display region and the transparent electrode pattern is located in the second display region. A filter is formed on an interior side of the second substrate. A common electrode is formed on the filter. A liquid crystal layer is disposed between the first substrate and the second substrate. A reflector is disposed on a side of the second substrate in the second display region.

The present invention improves on the prior art in that the novel LCD structure has a reflector disposed on a side of the second substrate and a transparent electrode pattern formed on the first substrate in the second display region. Thus, the LCD structure with a single liquid crystal layer according to the invention can display data on front and rear surfaces thereof, thereby reducing costs and ameliorating the disadvantages of the prior art.

### BRIEF DESCRIPTION OF THE DRAWINGS

The present invention can be more fully understood by reading the subsequent detailed description in conjunction with the examples and references made to the accompanying drawings, wherein:

FIG. 1 is a schematic view of a dual-display LCD structure according to an embodiment of the present invention.

### DETAILED DESCRIPTION OF THE INVENTION

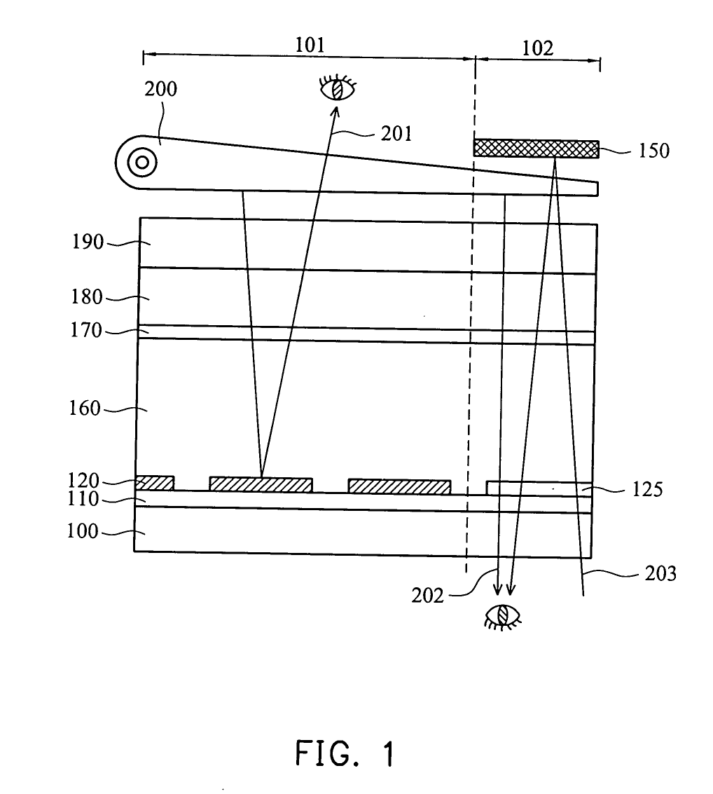

The present invention provides a dual-display LCD structure. FIG. 1 is a schematic view of a dual-display LCD structure according to an embodiment of the present invention.

In FIG. 1, the dual-display LCD structure has a first display region 101 and a second display region 102. Both the first display region 101 and the second display region 102 include at least one display area (pixel area). Here, the first display region 101 can serve as a main display region and the second display region 102 can serve as an auxiliary display region.

In FIG. 1, a first substrate 100 and a second substrate 190 opposite the first substrate 100 are provided. The first substrate 100 can be a transparent substrate, such as a glass or quartz substrate. The first substrate 100 can comprise a pixel driving element array (e.g. a thin film transistor array, not shown) formed thereon. The material of the second substrate 190 can be glass, quartz or the like.

In FIG. 1, a transparent insulation layer 110 can be formed on an interior surface of the first substrate 100. The transparent insulation layer 110 may be an organic layer.

In FIG. 1, using photolithography and etching, a reflective electrode pattern 120 and a transparent electrode pattern 125 is formed on the transparent insulation layer 110, wherein the reflective electrode pattern 120 is located in the first display region 101 and the transparent electrode pattern 125 is located in the second display region 102. The reflective electrode pattern 120 can be an aluminum layer or a silver layer formed by sputtering. The transparent electrode pattern 125 can be an indium tin oxide (ITO) layer or an indium zinc oxide (IZO) layer formed by sputtering.

In FIG. 1, a filter 180 is formed on the interior side of the second substrate 190. The filter 180 can be a color or monochromatic filter. In this embodiment, the color filter is preferred.

In FIG. 1, a common electrode 170 is formed on the filter 180. The common electrode 180 can be an indium tin oxide (ITO) layer or an indium zinc oxide (IZO) layer formed by sputtering.

In FIG. 1, a display material, such as liquid crystal molecules, is filled in a space between the first substrate 100 and the second substrate 190 to form a liquid crystal layer 160.

In FIG. 1, a reflector 150 is selectively disposed on the interior or exterior side of the second substrate 190 in the second display region 102. FIG. 1 shows the reflector 150 disposed on the exterior side of the second substrate 190 in the second display region 102, but is not intended to limit the present invention. The reflector 150 can be an aluminum layer or a silver layer. Additionally, a display housing whose interior surface is coated with a reflective layer can also serve directly as the reflector 150. Preferably the reflective layer 150 is made of a highly reflective material such as aluminum based metal.

In FIG. 1, a light source 200 can be disposed between the reflector 150 and the second substrate 190. The light source 200 can be a light emitting module including a cold cathode fluorescent tube and a light guiding panel. Thus, the dual-display LCD structure of the present invention is obtained.

It should be noted that, when the light source 200 is in the ON state, the light source 200 serves as a front light for the LCD structure in the first display region 101 and a backlight for the LCD structure in the second display region 102, as shown in FIG. 1. Nevertheless, when the light source 200 is in the OFF state, the ambient light serves as a reflective light source for the LCD structure in the first and second display regions 101, 102.

That is, the LCD structure in the first display region 101 is a reflective mode LCD. Referring to FIG. 1, a reflective light 201 from the light source 200 or the ambient light (not shown) reflects from the reflective electrode pattern 120 and displays the image on the outer side of the second substrate 190 (i.e. the viewer side).

The LCD structure in the second display region 102 is a transmissive or reflective mode LCD. For the transmissive mode, referring to FIG. 1, a transmissive light 202 from the light source 200 penetrates the LCD structure and displays the image on the outer side of the first substrate 100 (i.e. another viewer side). For the reflective mode, referring to FIG. 1, a reflective light 203 from the ambient light (not shown) reflects from the reflector 150 and displays the image on the outer side of the first substrate 100 (i.e. another viewer side). Therefore, the LCD structure with a single liquid crystal layer 160 according to the invention can display data on front and rear surfaces thereof.

In addition, depending on different designs, the first display region 101 and the second display region 102 can be abutting or separate.

Thus, the present invention provides a novel dual-display LCD structure with a single liquid crystal layer, a reflector disposed on a side of the second substrate and a transparent electrode pattern formed on the first substrate in the second display region. The display structure of the invention uses one display, only one set of electrical equipment for driving the LCD is required, thereby reducing costs, volume occupation, and ameliorating the disadvantages of the prior art.

Finally, while the invention has been described by way of example and in terms of the above, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A dual-display liquid crystal display structure having first and second display regions, comprising:
a first substrate and a second substrate opposite the first substrate;
a reflective electrode pattern and a transparent electrode pattern formed on the first substrate, wherein the reflective electrode pattern is located in the first display region and the transparent electrode pattern is located in the second display region;
a filter formed on an interior side of the second substrate;
a common electrode formed on the filter;
a liquid crystal layer interposed between the first substrate and the second substrate; and
a reflector disposed on a side of the second substrate in the second display region.

2. The dual-display liquid crystal display structure according to claim 1, further comprising:
a light source disposed between the reflector and the second substrate.

3. The dual-display liquid crystal display structure according to claim 1, wherein the first substrate is a glass substrate comprising a thin film transistor array.

4. The dual-display liquid crystal display structure according to claim 1, wherein the reflective electrode pattern is an aluminum layer or a silver layer.

5. The dual-display liquid crystal display structure according to claim 1, wherein the transparent electrode pattern is an indium tin oxide (ITO) layer or an indium zinc oxide (IZO) layer.

6. The dual-display liquid crystal display structure according to claim 1, wherein the common electrode is an indium tin oxide (ITO) layer or an indium zinc oxide (IZO) layer.

7. The dual-display liquid crystal display structure according to claim 1, wherein the reflector is formed on an interior side or an exterior side of the second substrate in the second display region.

8. The dual-display liquid crystal display structure according to claim 1, wherein the reflector is an aluminum layer or a silver layer.

9. The dual-display liquid crystal display structure according to claim 1, wherein the dual-display liquid crystal display structure is a reflective type liquid crystal display structure in the first display region.

10. The dual-display liquid crystal display structure according to claim 2, wherein the dual-display liquid crystal display structure is a transmissive type or a reflective type liquid crystal display structure in the second display region.

11. The dual-display liquid crystal display structure according to claim 1, wherein the first display region and the second display region are abutting or separate.

12. The dual-display liquid crystal display structure according to claim 1, wherein the filter is a color filter or a monochromatic filter.
